(19) United States
(12) Patent Application Publication
(10) Pub. No.: US 2008/0096666 A1
(43) Pub. Date: Apr. 24, 2008

(54) Gaming Machine With Self Changing Audio Configuration

(76) Inventors: Eric M. Pryzby, Skokie, IL (US); Alfred Thomas, Las Vegas, NV (US)

Correspondence Address: SCHWEGMAN, LUNDBERG & WOESSNER/WMS GAMING, P.O. BOX 2938, MINNEAPOLIS, MN, 55402, US

(21) Appl. No.: 11/573,149

(22) PCT Filed: Aug. 1, 2005
(86) PCT No.: PCT/US05/27276

§ 371 Date: Aug. 9, 2007

Related U.S. Application Data
(60) Provisional application No. 60/598,038, filed on Aug. 2, 2004.

(51) Int. Cl. G06F 17/00

(52) U.S. Cl. 463/42; 463/25; 709/213

(57) ABSTRACT

A computerized wagering game system has a gaming module comprising a processor and gaming code which is operable when executed on the processor to conduct a wagering game on which monetary value can be wagered. An audio configuration module is operable to change audio configuration over time for a specific game player.

### RELATED APPLICATION

This application claims the priority benefit of U.S. Provisional Application Ser. No. 60/598,038, filed 02 Aug. 2004, the contents of which are incorporated herein by reference.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### FIELD OF THE INVENTION

The invention relates generally to wagering gaming systems, and more specifically to a wagering game machine with self-changing audio configuration.

### BACKGROUND OF THE INVENTION

A wide variety of gaming devices are now available to gamers and to casino operators in computerized form, from slot machines to games that are traditionally played live such as poker and blackjack. These computerized games provide many benefits to the game owner and to the gambler, including greater reliability than can be achieved with a mechanical game or human dealer, more variety, sound, and animation in presentation of a game, and a lower overall cost of production and management.

Computerized video game systems must be designed with many of the same concerns as their mechanical and table game ancestors—they must be fair, they must provide sufficient feedback to the gamer to make the game fin to play, and they must meet a variety of gaming regulations to ensure that both the machine owner and gamer are honest and fairly treated in implementing the game. Further, they must provide a gaming experience that is at least as attractive as the older mechanical gaming machine experience to the gamer, to ensure success in a competitive gaming market.

Part of the gaming experience presented to game players is an audio and visual presentation that continually grows more sophisticated and complex, as computerized wagering game systems rapidly adopt new technologies. But, as a game player plays a computerized wagering game system over time, the audio presented as part of the gaming experience may become repetitive or lose its ability to hold the interest of the game player.

For example, sounds made during reel spin or during bang-up of credits won are typically always the same, and the background music and sounds played during other events typically do not vary in a particular wagering game machine. It is therefore desired that a computerized wagering game system present audio that is not static, and that does not lose the game player's interest.

### SUMMARY OF THE INVENTION

The present invention provides in one embodiment a computerized wagering game system having a gaming module comprising a processor and gaming code which is operable when executed on the processor to conduct a wagering game on which monetary value can be wagered, and an audio configuration module operable to change audio configuration over time for a specific game player.

### BRIEF DESCRIPTION OF THE FIGURES

FIG. 1 shows a computerized reel slot gaming system having an audio system, upon which the present invention may be practiced in some embodiments.

FIG. 2 is a block diagram of a computerized wagering game having a graphical volume control interface, consistent with an example embodiment of the present invention.

### DETAILED DESCRIPTION

In the following detailed description of sample embodiments of the invention, reference is made to the accompanying drawings which form a part hereof, and in which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the spirit or scope of the present invention. The following detailed description is, therefore, not to be taken in a limiting sense, and the scope of the invention is defined only by the appended claims.

The present invention provides in one exemplary embodiment a computerized wagering game system having a gaming module comprising a processor and gaming code which is operable when executed on the processor to conduct a wagering game on which monetary value can be wagered, and an audio configuration module operable to change audio configuration over time for a specific game player. Further embodiments comprise changing the wagering game's audio configuration in response to traffic in the wagering game establishment in which the wagering game system is installed, such that the audio configuration changes as the establishment becomes more or less busy.

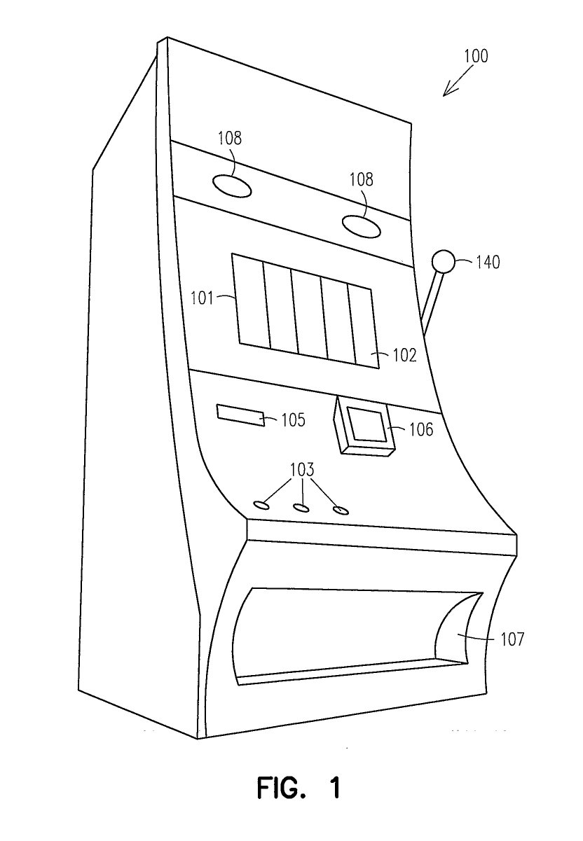

FIG. 1 illustrates a computerized wagering game machine, as may be used to practice some embodiments of the present invention. The computerized gaming system shown generally at 100 is a video gaming system, which displays information for at least one wagering game upon which monetary value can be wagered on video display 101. Alternate embodiments of the invention will have other game indicators, such as mechanical reels instead of the video graphics reels 102. The game of chance is played and controlled with various buttons 103, and in some embodiments also with a pull arm 104 to initiate reel spin. Value is wagered on the games, such as with tokens, coins, bills, or cards that hold value. The wagered value is conveyed to the machine through a changer 105 or a secure user identification module interface 106, and winnings are returned via the returned value card or through the coin tray 107. Sound is also provided through speakers 108, and is provided through an audio module under the control of the machine's processor and program code.

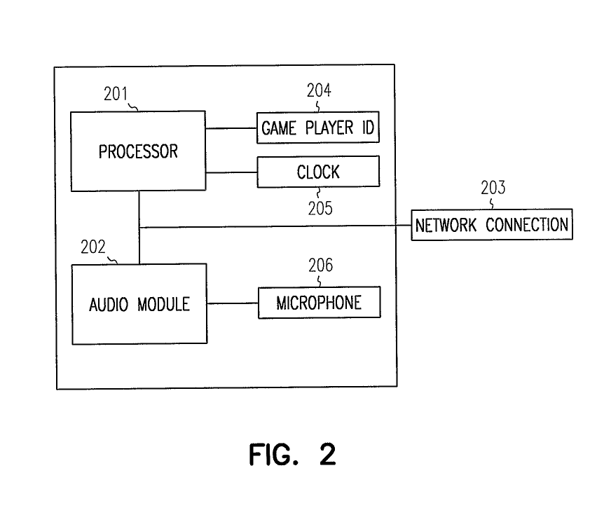

FIG. 2 is a block diagram of a computerized wagering game system having an audio module operable to change audio configuration over time for a specific game player, consistent with an example embodiment of the present invention. The system features a gaming module 201 that is operable to execute gaming code to conduct a computerized wagering game upon which monetary value can be wagered. In various embodiments of the invention the game will take various forms, including both well-known wagering games such as poker, blackjack, or slot machine games, as well as any other game upon which monetary value can be wagered. The gaming code also controls other elements of the computer that are used to facilitate operation of the wagering game, including hardware elements such as the audio module 202.

The audio module is used to present sound effects, music, and other sounds to complement the wagering game, to provide instruction to the game player, to attract potential game players to the wagering game machine, and for other purposes. The audio module receives instructions to play certain sounds from the gaming module, and plays them through one or more speaker such as speakers 108 of FIG. 1.

The gaming code executing on the processor also interacts with other hardware elements of the wagering game system, such as handling communication via a network connection 203. The example wagering game of FIG. 2 further includes a game player identification module 204 and an internal clock 205, along with a microphone 206 that is coupled to the audio module. These hardware elements are operated under control of the executing wagering game code to provide the wagering game machine with a self-changing audio configuration in various embodiments of the invention.

In operation, a player will typically begin a session of game play by depositing monetary value into the gaming machine, such as by inserting a player identification card carrying value into a game player identification module 204 (also shown as user identification module interface 106 in FIG. 1), or by depositing currency in the currency changer 105. Once credit is deposited, repeated gaming events are usually initiated by use of buttons or touchscreen, by which the game player repeatedly selects a wager amount and initiates a gaming event. During game play, results and other information is communicated to the game player via display 101, and by the audio module 202 and speakers 108. This feedback is designed not only to inform the game player of the status of the game, but also to entertain.

Sounds therefore would ideally not be repetitive or fatiguing, but would be sensitive to the game player and to the period of time the game player has been playing a particular wagering game machine. This is achieved in one embodiment of the present invention by changing the volume of certain sounds over time, or by altering the volume of components that make up a particular sound. For example, an audio track of music may change in volume, or the various instruments played to create the song may change in volume independently to vary the presentation of the song.

In other embodiments, the sounds themselves are changed after some period of time, so that music, sound effects, or other audio sounds are not repeated indefinitely but are changed over time. Various other embodiments include changing the complexity of sounds over time, such that different sounds are played or more elements are played to create a particular sound, and changing the sounds presented over time in response to traffic in the gaming establishment or near the wagering game machine.

Traffic may be determined or estimated in networked wagering game machines by communicating which gaming machines are being used to other gaming machines via the network interface, or by estimation of the sound level in the gaming establishment such as via microphone 206. In network communication, machines may be configured to receive information regarding which machines round them are being used, or may receive statistics for a pool of machines of the same type or within a gaming establishment. By knowing the number of wagering game machines that are currently being used, the wagering game can estimate the approximate amount of traffic in the wagering game facility and adjust the volume accordingly. When using a microphone, direct readings of the sound level within the gaming establishment are taken, and are used to adjust the volume to an appropriate level.

In other embodiments of the invention, the wagering game changes audio configuration over time based on a player's identity or other player characteristics. Use of a game player tracking module 204, such as a player tracking card reader or other such device, enables the wagering game machine to both identify a particular game player, and to track his game play over time. The wagering game can then monitor not just how long a particular game player has been playing a specific wagering game machine, but can also track how much time the game player has spent playing similar machines or different wagering games, and can adjust the audio presentation over time based on these metrics.

Such a system incorporates in further embodiments tiers or levels of player activity, such that preferred players or those having reached certain levels may be automatically recognized and audio configuration can be automatically set based on their identity and level. For example, a personal greeting may be extended to players of a certain level or above, and a player's customized audio settings maybe retained between sessions. A preferred player's jackpots may result in special, more complex, or louder sounds announcing jackpots or other such game events, in recognition of the player's preferred status.

These examples illustrate how the audio configuration of a computerized wagering game machine can be self-changing, thereby making the audio presentation of the wagering game more interesting and less repetitive to the game player. It also illustrates how some embodiments of the invention will use self-changing audio configuration to adjust for the wagering game machine's environment, or to recognize players of a certain level or status with special audio features.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the claims, and the full scope of equivalents thereof.

1. A computerized wagering game system, comprising:
a gaming module comprising a processor and gaming code which is operable when executed on the processor to conduct a wagering game on which monetary value can be wagered;
an audio configuration module operable to change audio configuration over time for a specific game player based on at least one metric measured over a period of time longer than two game events for the specific game player.

2. The computerized wagering game system of claim 1, wherein the game player is identified by a player tracking device.

3. The computerized wagering game system of claim 1, wherein changing audio configuration over time for a specific game player comprises changing volume.

4. The computerized wagering game system of claim 1, wherein changing audio configuration over time for a specific game player comprises changing the sounds played on the occurrence of certain events.

5. The computerized wagering game system of claim 1, wherein changing audio configuration over time for a specific game player comprises playing a special welcome for players who are preferred players.

6. The computerized wagering game system of claim 1, wherein changing audio configuration over time for a specific game player comprises changing the complexity of sounds presented.

7. The computerized wagering game system of claim 1, further comprising changing the audio configuration in response to traffic in a gaming establishment in which the computerized wagering game machine is installed.

8. A method of operating a computerized wagering game system, comprising:
playing a wagering game on which monetary value can be wagered by executing gaming code on a processor; and
changing an audio configuration over time for a specific game player based on at least one metric measured over a period of time longer than two game events for the specific game player.

9. The method of claim 8, further comprising identifying the specific game player via a player tracking device.

10. The method of claim 8, wherein changing audio configuration over time for a specific game player comprises changing volume.

11. The method of claim 8, wherein changing audio configuration over time for a specific game player comprises changing the sounds played on the occurrence of certain events.

12. The method of claim 8, wherein changing audio configuration over time for a specific game player comprises playing a special welcome for players who are preferred players.

13. The method of claim 8, wherein changing audio configuration over time for a specific game player comprises changing the complexity of sounds presented.

14. The method of claim 8, further comprising changing the audio configuration in response to traffic in a gaming establishment in which the computerized wagering game machine is installed.

15. A machine-readable medium with instructions stored thereon, the instructions when executed operable to cause a computerized system to:
play a wagering game on which monetary value can be wagered by executing gaming code on a processor; and
change an audio configuration over time for a specific game player based on at least one metric measured over a period of time longer than two game events for the specific game player.

16. The machine-readable medium of claim 15, the instructions further operable to cause the computerized system to identify the specific game player via a player tracking device.

17. The machine-readable medium of claim 15, wherein changing audio configuration over time for a specific game player comprises changing volume.

18. The machine-readable medium of claim 15, wherein changing audio configuration over time for a specific game player comprises changing the sounds played on the occurrence of certain events.

19. The machine-readable medium of claim 15, wherein changing audio configuration over time for a specific game player comprises playing a special welcome for players who are preferred players.

20. The machine-readable medium of claim 15, wherein changing audio configuration over time for a specific game player comprises changing the complexity of sounds presented.

21. The machine-readable medium of claim 15, the instructions further operable to cause the computerized system to change the audio configuration in response to traffic in a gaming establishment in which the computerized wagering game machine is installed.

22. A computerized wagering game system, comprising:
a gaming module comprising a processor and gaming code which is operable when executed on the processor to conduct a wagering game on which monetary value can be wagered;
an audio configuration module operable to change audio configuration over time for a specific game player based on at least one metric measured over a period of at least fifteen minutes.

23. A computerized wagering game system, comprising:
a gaming module comprising a processor and gaming code which is operable when executed on the processor to conduct a wagering game on which monetary value can be wagered;
an audio configuration module operable to change audio configuration over time for a specific game player based on at least one metric measured over a period of at least ten game events.
